(19) United States
(12) Patent Application Publication
(10) Pub. No.: US 2012/0007368 A1
(43) Pub. Date: Jan. 12, 2012

(54) PRESSURE REDUCTION PLANT FOR A GAS OR GAS MIXTURE

(76) Inventor: Antonio Jose Silva Valente, Quinta do Conde (PT)

(21) Appl. No.: 13/146,558

(22) PCT Filed: Apr. 20, 2009
(86) PCT No.: PCT/PT2009/000022

§ 371 Date: Jul. 27, 2011

(30) Foreign Application Priority Data
Apr. 21, 2008 (PT) 104023

(51) Int. Cl. H02K 7/18; F25J 1/00

(52) U.S. Cl. 290/1 R; 62/606

(57) ABSTRACT

The present invention relates to a pressure reduction plant for a gas or gas mixture and recovering of the pressure power lost by said gas or gas mixture, the said gas or the said gas mixture flowing through at least a driving turbine of an electrical power turbo generator set, which comprises a high pressure inlet pipeline (6, 6c, 6d) through which said gas feeds said Tesla turbine, a flow rate control valve (9), a flowmeter (10), at least a Tesla turbine (T, Ta, Tb, Tc, Td), an exit low pressure pipe (4, 4a,4b, 4c, 4d) of the Tesla turbine of the gas with reduced pressure, a flow rate control valve (14), a flowmeter (13), a security valve (15) and a final exit pipeline (16) of the gas with reduced pressure, being said at least one driving Tesla turbine (T, Ta, Tb, Tc, Td) at least an electric power generator, which generator (7, 7a, 7b, 7c, 7d) supplies the generated power by means of a connection cable (11, 11a, 11b, 11c, 11d) to a transforming and delivering power unit (12), connected through a connection cable (18) to devices of the plant itself or through an exportation cable (29) to an external grid.

### FIELD OF THE INVENTION

The present invention relates to a pressure reduction plant for a gas or gas mixture and recovering of the pressure power lost by said gas or gas mixture, during the reduction of the pressure of said gas or gas mixture, transforming it into mechanical power, using at least a turbo generator set driven by at least a Tesla turbine.

### PRIOR ART

The Tesla turbines transform the pressure power of a gas or gas mixture into mechanical power, by the rotation of a shaft coupled to one or several flat and parallel discs arranged in an appropriate way, this kind of turbine having been originally described by Nikola Tesla in the U.S. Pat. Nos. 1,061,142 and 1,061,206.

In the present state of the art the pressure reduction of gases or gas mixtures is obtained by several processes, in pressure reduction stations, the most common, based on the Joule-Thomson effect also known by Joule-Kelvin effect, in all processes being generated an important temperature reduction, which accompanies its expansion through a mechanical restriction, adjustable, normally an expander valve, it being necessary to spend power to heat again said expanded gas to posterior use.

There are also known in the state of the art pressure recovering plants, by means of turbo generators, associated with natural gas pressure reduction stations, associated with gas pipelines, which also take advantage of part of the gas pressure drop. The electric power is generated by such turbo generators, which is primarily used to reheating the gas after the same has undertaking a reduction to the temperature and pressure of delivering to consumers.

Furthermore, in the gas liquefaction plants, in which it is processed the liquefaction of great masses of gas or of gas mixtures, according to the present state of the art, said gas or gas mixture is subjected to a compression followed by the extraction of the released heat, through refrigerating means, in order to lower its temperature to the required values with elevated power consumption and pollution.

### DESCRIPTION OF THE INVENTION

The present invention will be described, for easier exposition, with reference to natural gas pressure reduction plants, without constituting in any way a limitation of the invention, the same being able to be applied equally to any gas or gas mixture.

The present invention has for its object a pressure reduction plant of a gas or gas mixture, normally referred as natural gas, for delivering to consumers, which turns compulsory that said gas, normally stored at high pressures, in the range of 6000 kPa (G) at the room temperature of about 20° C., is submitted to a pressure reduction process compatible with the specifications of the consumer delivering contract, normally, for a pressure in the range of 1600 kPa (G) at the temperature of 5° C. for the delivering networks in a first steep and yet to a process of pressure reduction to about 200 kPa (G) at the same temperature of 5° C. for the users.

It was surprisingly found that during the feeding of natural gas to a Tesla turbine, the temperature variation thereof between the inlet and the outlet of said turbine is quite lower to what happens with a conventional turbine, considering the same pressure differential between the inlet and the outlet of the turbine.

Thus, the present invention has for its object to take advantage of that singularity, using a turbo generator for reducing the pressure of a flow rate of natural gas, wherein it is used a Tesla turbine, for the recovery of the lost pressure power, transforming the same in mechanical power, simultaneously with the reduction of the pressure of the natural gas in a pressure reduction plant associated with a gas pipeline, in order that, after the process wherein the gas is subjected to a pressure reduction and its temperature adjusted to the required values, will said gas be able to be send for use for the delivering networks to the consumers, in a more economic way than what is presently achieved.

As a concrete exemplification of a pressure reduction plant, associated with a gas pipeline according to the state of the art, using reducer pressure valves, in a practical situation of the industry, for a certain natural gas composition initially stored at 6500 kPa (G) and at about 15° C. that requires to be submitted to a first steep of pressure reduction for a contractual specification of 1600 kPa (G) at 5° C., it is obtained a temperature reduction of 0,5° C. per each 100 kPa (G) of pressure reduction obtained, the total temperature reduction being in the range of 24° C.

In these pressure reduction stations it is necessary to proceed to a posterior reheating of said natural gas that has lowered its temperature to a final value of −9° C., to a contractual value of 5° C. positive at the pressure of 1600 kPa (G), that is, a reheating of the gas mass flow rate in the range of 14° C.

Even if a power recovering is done by means of a conventional turbo generator that is still very expensive in both energetic and economic aspects.

The use of one or more Tesla turbines according to the present invention in this case enables not only the elimination of the need of reheating the gas, which temperature will have a little variation during the process of pressure reduction, as well as selling all the electric power produced at least by a turbo generator set driven at least by a Tesla turbine.

It is another object of the present invention to provide a pressure reduction plant for a combustible gas mixture comprised by several turbo generator sets driven by Tesla turbines, arranged in series.

It is still an object of the present invention to provide a pressure reduction plant for a combustible gas mixture comprised by several turbo generator sets driven by Tesla turbines, arranged in parallel.

It is yet another object of the present invention further provide a pressure reduction plant for a combustible gas mixture comprised by flow rate control valves, pressure control valves, security valves and isolation valves downstream and upstream of one or several turbo generator sets driven by Tesla turbines, in order to regulate the amount of processed gas, its pressure reduction and guarantee the security and operability of the plant.

It is another object of the present invention to provide a pressure reduction plant for liquefaction of a combustible gas mixture, in which is done the liquefaction of great masses of gas or gas mixtures. Said gas to be liquefied is used as motive fluid by one or several of the turbo generator sets, driven by Tesla turbines, arranged in cascade, in series and/or in parallel and/or in series and parallel, the said gas in the exit part being liquefied by cooling in a refrigerating circuit.

The plant object of the present invention is defined by the features of the claim 1, the details of its several embodiments being defined in the following sub-claims.

Further features and details of the present invention will be elucidated on the basis of a description of preferred embodiments, given as non-limiting illustrative examples, with reference to the attached drawings, in which:

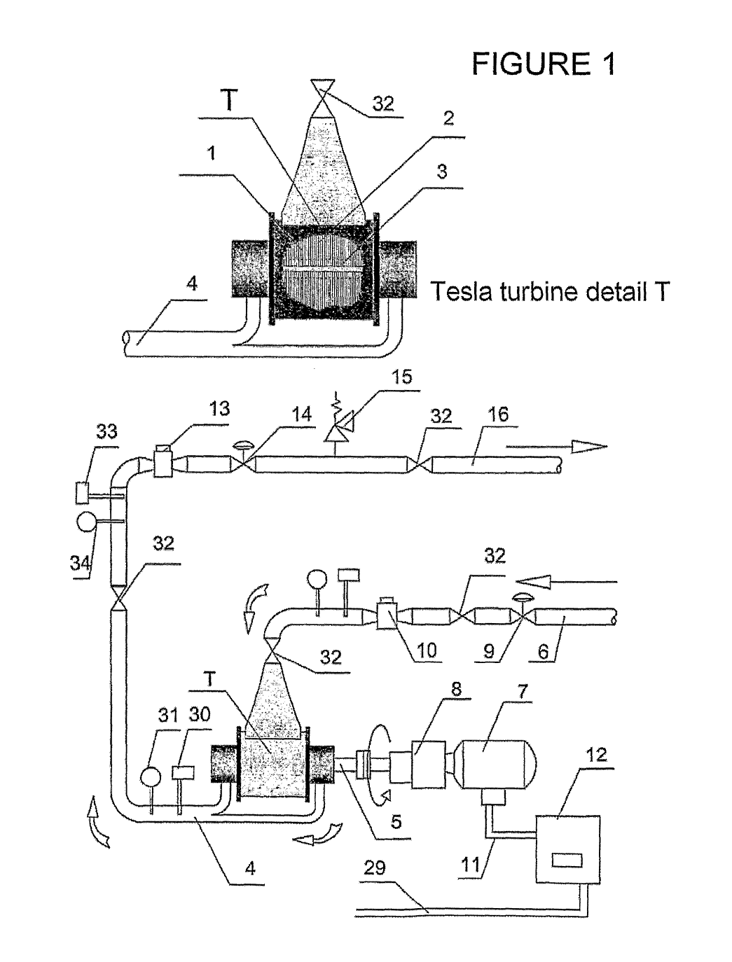

FIG. 1 shows a simplified schematic illustration of a first embodiment of the plant according to the present invention and a simplified schematic illustration of a partial section of a Tesla turbine;

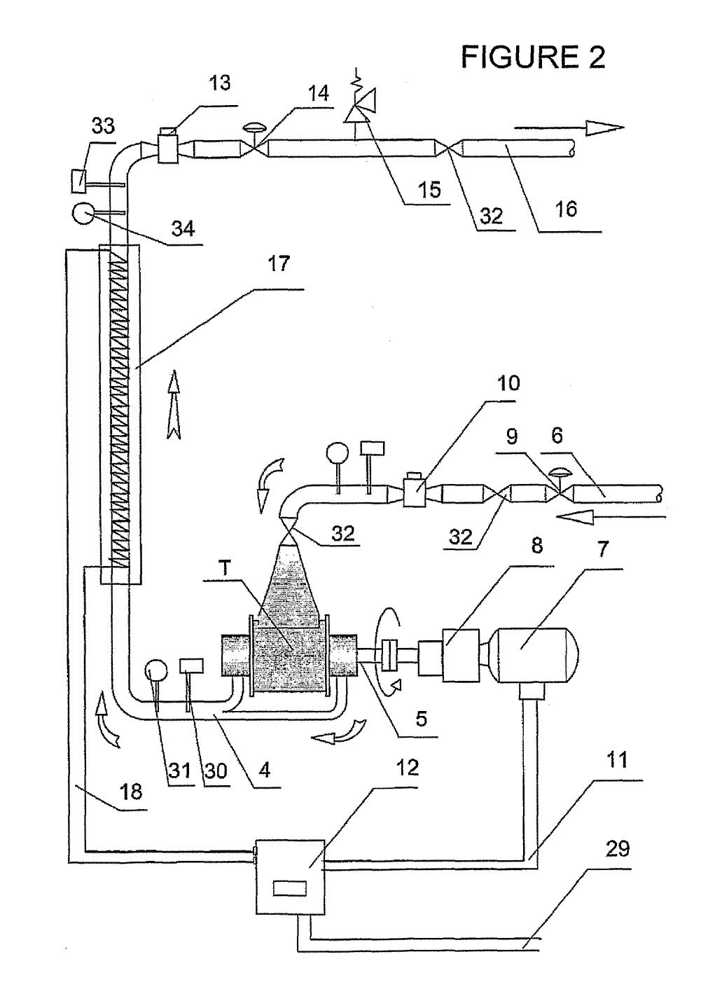

FIG. 2 shows a simplified schematic illustration of a second embodiment of the plant according to the present invention;

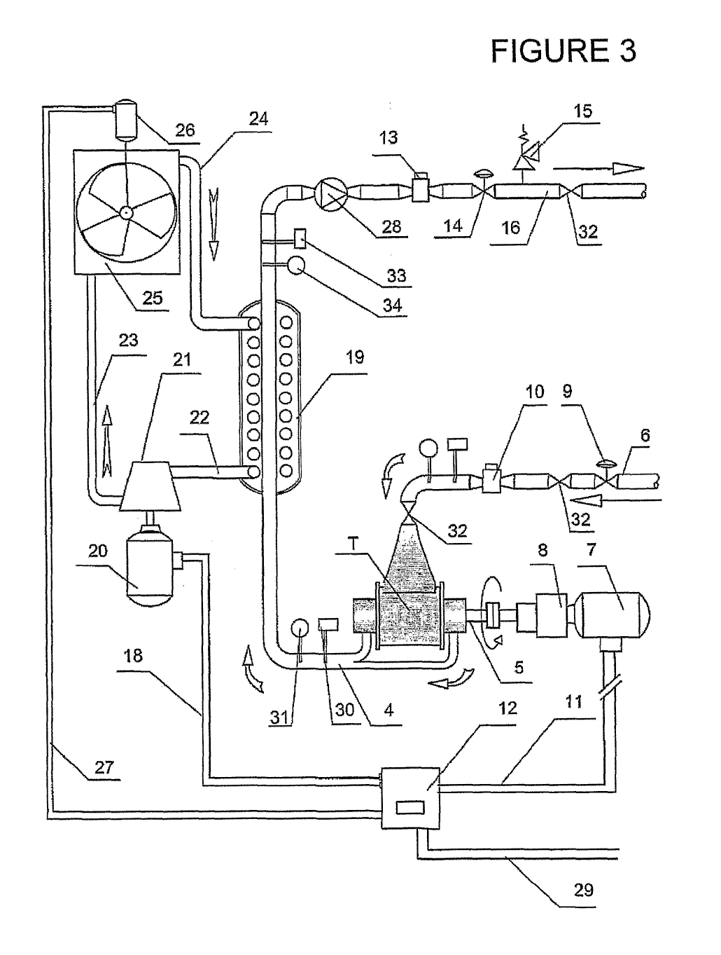

FIG. 3 shows a further simplified schematic illustration of a third embodiment of the plant according to the present invention;

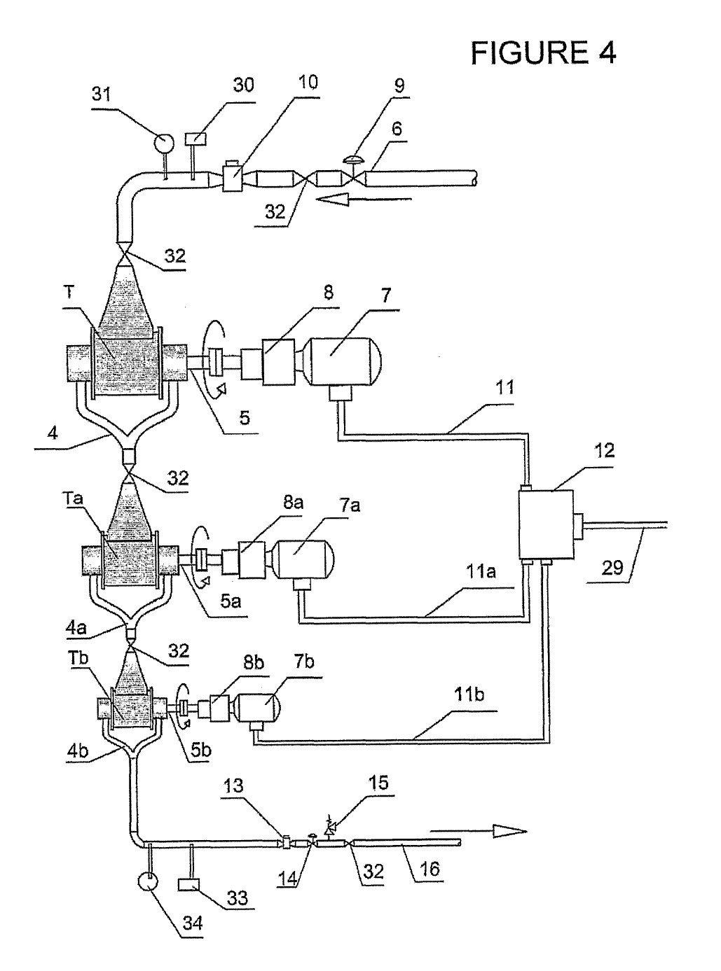

FIG. 4 shows a further simplified schematic illustration of a fourth embodiment of the plant according to the present invention;

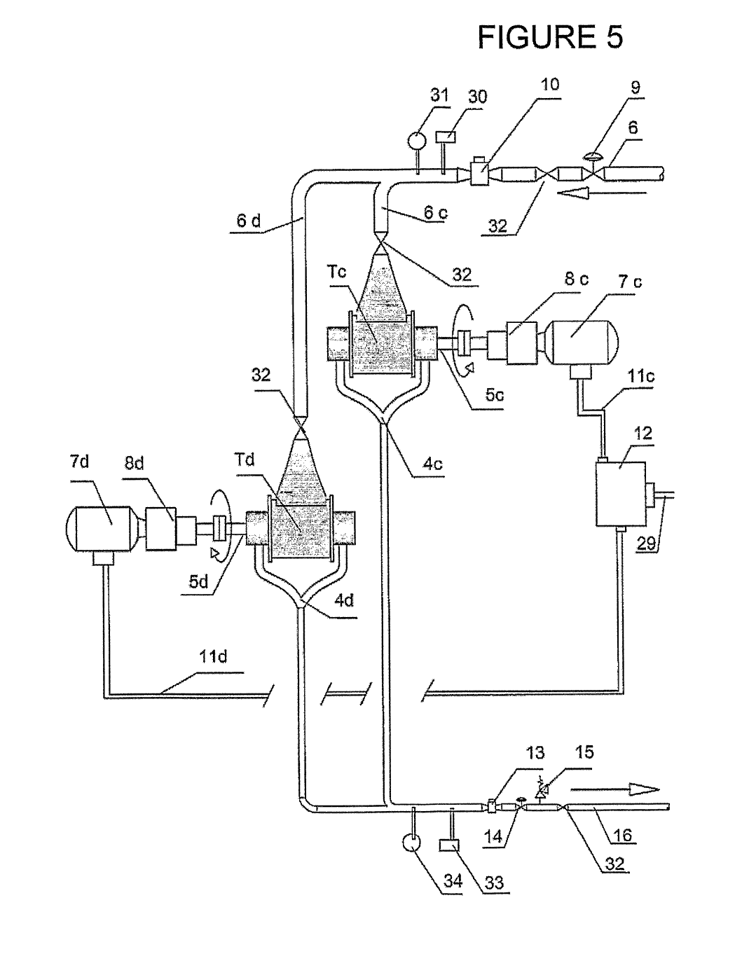

FIG. 5 shows a further simplified schematic illustration of a fifth embodiment of the plant according to the present invention.

In the FIG. 1 it is schematically shown a first embodiment of the plant according to the invention, which operates as natural gas pressure reduction plant by means of the use of a Tesla turbine T, inserted in the natural gas pipeline which pressure is intended to be reduce, in which it is done a pressure reduction of said natural gas, with low temperature reduction, being generated electric power by the respective turbo generator set. The gas entering in the turbine through the high pressure pipeline 6, with a mass flow rate controlled by the flow rate control valve 9, associated with the flowmeter 10, leaves after undertaking a power loss with low temperature reduction in the Tesla turbine T, with its pressure reduced through the low pressure pipe 4. The gas with reduced pressure will be delivered for the final use through the pipeline 16, its flow rate being regulated by the control valve 14, associated with the flowmeter 13, the pipeline being protected against eventual overpressure by the security valve 15.

The rotor 1 of the Tesla turbine T drives the electrical power generator 7 through respectively its shaft 5 and the reduction gear 8. The electrical power generator 7 supplies the electric power generated through the connection cable 11 to a transforming and delivering electrical unit 12 which, in turn, is connected to the power exportation grid through the exportation cable 29. There are shown the shut off valves 32, which serve, for example, for isolation of the turbine and remaining equipment in case of need. The process temperature is controlled by the thermometer 30 and the pressure by the pressure gauge 31 installed in the high pressure pipe and by the thermometer 33 and pressure gauge 34 installed in the low pressure pipes.

It is schematically shown in the FIG. 2 a second embodiment of the plant according to the invention, this embodiment differs from the first by the fact that a part of the electric power, produced by the turbo generator set 7 driven by a Tesla turbine T, be able to be used to heat the processed gas, by means of an electrical exchanger 17, in the cases wherein the need for use thereof so determines, that is, in the case of the gas with reduced pressure, flowing in low pressure pipe 4, requires heating for processing or contractual reasons before its delivery for the final use through the pipeline 16, that part of the electric power being generated by the power generator 7, sent to a transforming and delivering electrical unit 12, which supplies it through the connection cable 18 to an electrical exchanger 17, mounted in the low pressure pipe 4, which is intended for heating of said gas. The gas with reduced pressure from the pipe 4 after heating will be delivered for the final use through the pipeline 16, its flow rate being regulated by the flow rate control valve 14, associated with the flowmeter 13, the pipeline being protected from eventual overpressure by the security valve 15.

The electric power generated and not used for heating the gas, is delivered to the power exportation grid through the exportation cable 29, through the same transforming and delivering electrical unit 12.

It is schematically shown in the FIG. 3 a third embodiment of the plant according to the invention, for the liquefaction by pressure reduction with low temperature variation of a gas mixture such as propane, butane and methane, wherein in a first steep of the process comprising a reduction of specific volume and corresponding volumetric flow rate it is done in the Tesla turbine T of a turbo generator set, which consists in a pressure reduction with low temperature variation of said mixture. The electric power is also generated and said electric power being total or partially used simultaneously to drive a cryogenic circuit which will complement the cooling of said gas mixture in order to obtain its liquefaction.

The gas mixture to liquefy enters through the high pressure pipeline 6 in the Tesla turbine T where it undertakes a specific volume reduction and pressure reduction at a substantially constant temperature, driving in rotation the rotor 1 (not shown), transforming pressure power of the gas mixture into mechanical power that will be transmitted by the rotation of the shaft 5 of the Tesla turbine T to a reduction gear 8, which in turn will drive an electrical power generator 7. The low pressure gas mixture leaves the Tesla turbine T through the low pressure pipe 4, passes through a cooling exchanger 19, in which circulates in counter-current a coolant fluid, which enters by the inlet pipe 24, after having been cooled in the cooler 25. Said coolant fluid leaves the exchanger 19 through the pipe 22 with its temperature increased due to the thermal exchange with the gas mixture to liquefy and will be compressed in the compressor 21 driven by the engine 20 and it is returned through the pipe 23 to said cooler 25, where its temperature is reduced by thermal exchange with the surrounding environment.

The engines 20 and 26 of the cooling plant of the gas to be liquefied are driven partially or totally by the electric current generated in the generator 7 and received through the transforming and delivering electrical unit 12, respectively, through the connection cables 18 and 27. There will be further situations where it is possible to provide additional electric power to the external power grid through the power exportation cable 29, which will serve also for importation electrical power from external power grid in the reverse situation.

The gas mixture (NGL) will pass from the gaseous phase to the liquid phase by cooling in the exchanger 9, being next pumped through the exportation pump 28, for delivering for the final use through the pipeline 16, its flow rate being controlled by the flow rate control valve 14, associated with the flowmeter 13, the pipeline being protected against eventual overpressure by the security valve 15.

In FIG. 4 there is schematically shown a fourth embodiment of the plant according to the invention, wherein several turbo generator sets driven by Tesla turbines are mounted in series, in order to obtain a final reduction of the pressure, with low temperature reduction, in several steeps, to optimise the size of each turbine.

The gas enters in the plant through the high pressure pipeline 6 with the flow rate controlled by the flow rate control valve 9, associated with the flowmeter 10, its pressure and temperature parameters being measured, respectively, by pressure gauge 31 and thermometer 30, passing to the first pressure reduction steep with low temperature reduction in the first Tesla turbine T, leaving it through the low pressure pipe 4 and being generated electric power by the electric power generator 7.

Said gas, after the first pressure reduction steep, passes to the second pressure reduction steep with low temperature reduction in the second Tesla turbine Ta, leaving it through the low pressure pipe 4a and being generated electric power by the second generator 7a.

Said gas, after the second pressure reduction steep, passes to the third pressure reduction steep with low temperature reduction in the third Tesla turbine Tb, leaving it through the low pressure pipe 4b and being generated electric power by the third generator 7b.

The gas or gas mixture leaves then in the required conditions from the third Tesla turbine Tb through the low pressure pipe 4b, for final use through the exportation pipeline 16, its flow rate and pressure being controlled by the flow rate control valve 14, associated with the flowmeter 13, and the security of the system being guaranteed by the pressure control valve 15 mounted in pipeline 16. The final pressure and temperature will be measured, respectively, by the pressure gauge 34 and thermometer 33.

The electric power generated by the three generators 7, 7a and 7b will be delivered to the transforming and delivering electrical unit 12 through the connection cables 11, 11a and 11b, from where it is exported through the exportation cable 29 to an external grid.

In FIG. 5 there is schematically shown a further plant for carrying out the process according to the invention, wherein two turbo generated sets driven by

Tesla turbines are arranged in parallel in order to be obtained a final pressure reduction with low temperature reduction, when of the mass flow rate so determines, in order to optimise the size of each turbine.

In this plant there are used two generator sets driven by the Tesla turbines Tc and Td arranged in parallel, in order to optimise the size of each turbine, in cases where it is necessary, due to the great mass flow rate to process. The gas enters in the system through the high pressure pipeline 6 with flow rate, controlled by the flow rate control valve 9, associated with the flowmeter 10, its pressure and temperature parameters being measured, respectively, by the pressure gauge 31 and by the thermometer 30, the flow rate being divided for two Tesla turbines Tc and Td through the high pressure pipes 6c and 6d respectively.

In each turbine there is simultaneously carried out a pressure reduction with low temperature reduction, the gas or gas mixture leaving with reduced pressure and with low temperature reduction, respectively, through the low pressure pipes 4c and 4d, through which it is delivered to the common exportation pipeline 16, its flow rate being controlled by the flow rate control valve 14, associated with the flowmeter 13 and its pressure and temperature measured, respectively, by the thermometer 33 and by the pressure gauge 34, and the security of the system guaranteed by the security valve 15 mounted in the exportation pipeline 16.

The electric power generated by the two generators 7c and 7d will be delivered to the transforming and delivering electrical unit 12 through the connection cables 11c and 11d, from where it will be exported through the exportation cable 29 to the external electrical grid.

Without departing from the scope of the invention it is possible for one skilled in the art to realise all the modifications and developments suggested by his normal skill and the natural evolution of the art, in the process and plant carrying out the object of the present invention.

1- Pressure reduction plant for a gas or gas mixture and for recovering the lost pressure power by said gas or gas mixture, the said gas or the said gas mixture flowing through at least a driving turbine of a turbo generator set, characterised in that it comprises a high pressure inlet pipeline (6, 6c, 6d), a flow rate control valve (9), a flowmeter (10), at least a Tesla turbine (T, Ta, Tb, Tc, Td), a low pressure pipe (4, 4a, 4b, 4c, 4d), a flow rate control valve (14), a flowmeter (13), a security valve (15) and an exit pipeline (16), being said at least one driving Tesla turbine (T, Ta, Tb, Tc, Td) at least a turbo generator set, which generator (7, 7a, 7b, 7c, 7d) supplies the generated power by means of a connection cable (11, 11a, 11b, 11c, 11d) to a transforming and delivering power unit (12), connected by means of a connection cable (18) to devices of the plant itself or through an exportation cable (29) to an external grid.

2- Plant according to the claim 1, characterised in that it further comprises an electrical exchanger (17).

3- Plant according to the claim 1, characterised in that it comprises several turbo generator sets driven by Tesla turbines (T, Ta, Tb), arranged in series.

4- Plant according to the claim 1, characterised in that it comprises at least two turbo generators sets driven by at least two Tesla turbines (Tc, Td) arranged in parallel.

5- Plant according to the claim 1, characterised in that it comprises several turbo generators sets driven by several Tesla turbines (T, Ta, Tb, Tc, Td, etc.), which are arranged in series assemblies, with the several series assemblies arranged in parallel.

6- Plant according to any of the previous claims, characterised in that it comprises heating means (17).

7- Plant according to any one of the previous claims for liquefaction, characterised in that it comprises refrigerating means (19, 20, 21, 22, 23, 24, 25, 26).
